(19) United States
(12) Patent Application Publication
(10) Pub. No.: US 2003/0102077 A1
(43) Pub. Date: Jun. 5, 2003

(54) Method for manufacturing a copper-clad laminate

(75) Inventor: Chien-Hsin Ko, Chungli City (TW)

Correspondence Address: MERCHANT & GOULD P.C., P.O. Box 2903, Minneapolis, MN, 55402-0903, US

(73) Assignee: Pioneer Technology Engineering Co., Ltd.,

(21) Appl. No.: 10/008,819

(22) Filed: Dec. 3, 2001

(51) Int. Cl. B32B 31/26

(52) U.S. Cl. 156/230

(57) ABSTRACT

A method for manufacturing a copper-clad laminate includes the steps of forming first and second copper films on first and second carriers, sandwiching a prepreg containing a curable resin body, between a first assembly of the first carrier and the first copper film, and a second assembly of the second carrier and the second copper film, and vacuum hot pressing the prepreg and the first and second assemblies so as to completely cure the curable resin body of the prepreg to form a cured resin body that is bonded to the first and second copper films of the first and second assemblies.

### BACKGROUND OF THE INVENTION

1. Field of the Invention

This invention relates to a method for manufacturing a copper-clad laminate with ultra-thin copper films.

2. Description of the Related Art

Copper-clad laminates are used in the production of printed circuit boards. It is desirable to use relatively thin copper foils (less than 16 microns) on the copper-clad laminates for the production of printed circuit boards with compact and highly integrated circuit patterns thereon due to drawbacks, such as side etching effect during etching process for the formation of circuit lines on the printed circuit boards, and time consuming and undesirable enlargement of through-holes during the process of the formation of the through-holes in the printed circuit boards via laser beam, which are consequences of using thick copper foils in the processing of the printed circuit boards. However, conventionally, copper foils are made by electrodeposition techniques and are hard to produce with the desired thickness without formation of pinholes. Moreover, even if such thin copper foils can be produced, they are difficult to store and transport, and are susceptible to folding when laminated with a substrate (which is generally called a prepreg that is in the form of a fabric sheet coated with curable epoxy resin or a glass-fiber reinforced curable epoxy resin sheet) during a hot pressing step. A conventional process for the production of the printed circuit boards involves forming relatively thick copper foils on a glass-fiber reinforced epoxy resin substrate and subsequently etching the copper foils to achieve the desired thickness. As a consequence, the process induces environmental problems and results in uneven surfaces for the copper foils.

### SUMMARY OF THE INVENTION

Therefore, the object of the present invention is to provide a method for manufacturing a copper-clad laminate with ultra-thin copper films that is capable of overcoming the aforementioned drawbacks.

According to the present invention, a method for manufacturing a copper-clad laminate comprises the steps of: preparing rigid plate-shaped first and second carriers having first and second flat surfaces, respectively; forming ultra-thin first and second copper films on the first and second flat surfaces of the first and second carriers, respectively, via electroplating techniques; sandwiching a prepreg, which is in the form of a glass-fiber reinforced resin sheet containing a curable resin body, between a first assembly of the first carrier and the first copper film, and a second assembly of the second carrier and the second copper film in a manner that the first and second copper films are brought into contact with two opposite sides of the prepreg; hot pressing the first and second assemblies and the prepreg so as to completely cure the curable resin body of the prepreg to form a cured resin body that is bonded to and that cooperates with the first and second copper films of the first and second assemblies to form a laminated body; and removing the first and second carriers from the laminated body.

### BRIEF DESCRIPTION OF THE DRAWINGS

In drawings which illustrate an embodiment of the invention,

FIG. 1 is a block diagram to illustrate consecutive steps for forming a copper-clad laminate according to the preferred embodiment of a method of this invention;

FIG. 2 illustrates the formation of ultra-thin first and second copper films on rigid plate-shaped first and second carriers according to the preferred embodiment;

FIG. 3 illustrates the step of stacking and hot pressing a prepreg and the thus formed first assembly of the first carrier and the first copper film, and the second assembly of the second carrier and the second copper film in FIG. 2 to form a laminated body according to the preferred embodiment; and

FIG. 4 illustrates the formation of a final product of a copper-clad laminate by removing the first and second carriers from the laminated body in FIG. 3 according to the preferred embodiment.

### DETAILED DESCRIPTION OF THE PREFERRED EMBODIMENT

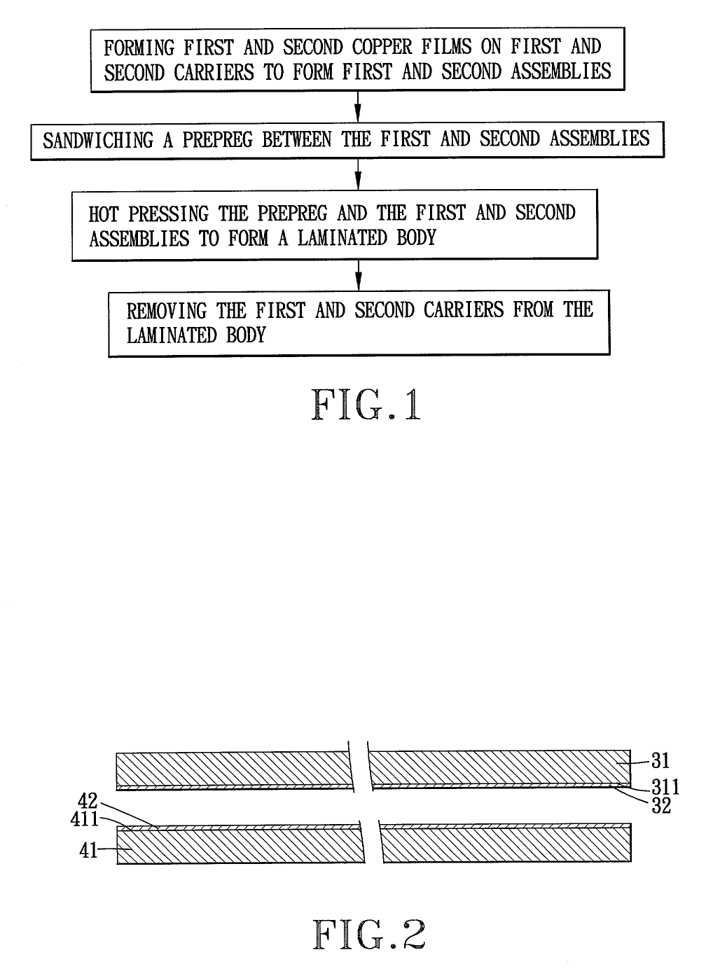

FIG. 1 illustrates consecutive steps for forming the preferred embodiment of a copper-clad laminate 8 (see FIG. 4) according to the method of this invention.

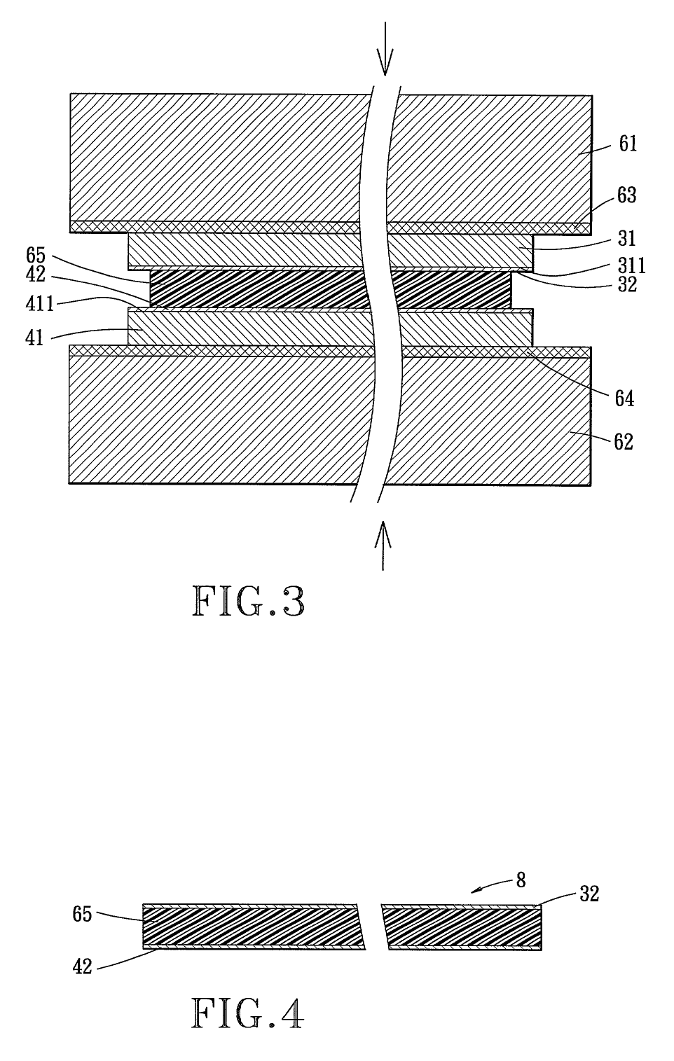

With further reference to FIGS. 2 to 4, the method includes the steps of: preparing rigid plate-shaped first and second carriers 31, 41 having first and second flat surfaces 311, 411, respectively; cleaning and polishing the first and second flat surfaces 311, 411; roughening the first and second flat surfaces 311, 411 by acid washing; forming ultra-thin first and second copper films 32, 42 on the first and second flat surfaces 311, 411 (see FIG. 2), respectively, via electroplating techniques; roughening the first and second copper films 32, 42 by etching techniques; water washing and subsequently drying the first and second copper films 32, 42; sandwiching a prepreg 65, which is in the form of a glass-fiber reinforced resin sheet containing a curable resin body, such as epoxy resin, between a first assembly of the first carrier 31 and the first copper film 41, and a second assembly of the second carrier 41 and the second copper film 42 in a manner that the first and second copper films 32, 42 are brought into contact with two opposite sides of the prepreg 65 (see FIG. 3); vacuum hot pressing the first and second assemblies and the prepreg 65 using opposing press plates 61, 62 in a hot press apparatus (not shown) so as to completely cure the curable resin body of the prepreg 65 to form a cured resin body that is bonded to and that cooperates with the first and second copper films 32, 42 of the first and second assemblies to form a laminated body, a pair of opposing kraft paper sheets 63, 64 being provided to sandwich the assembly of the prepreg 65 and the first and second assemblies to provide a cushioning effect during the hot pressing; and cooling and subsequently removing the first and second carriers 31, 41 from the laminated body by peeling to form the final product of the copper-clad laminate 8.

Each of the first and second carriers 31, 41 is made from a material selected from a group consisting of steel, aluminum, copper, iron, high density polyethylene, cured glass-fiber reinforced epoxy resin, fluorocarbon polymers, and Bakelite, such as polyethylene, polypropylene, polystyrene, etc. Preferably, each of the first and second carriers 31, 41 is made from a steel plate.

The cleaning of the first and second flat surfaces 311, 411 of the first and second carriers 31, 41 can be carried out via known cleaning techniques, such as washing with detergents and water and treating with ultraviolet rays and ozone or with plasma.

The purpose of roughening the first and second flat surfaces 311, 411 of the first and second carriers 31, 41 is to enhance bonding strengths between the first flat surface 311 and the first copper film 32 and between the second flat surface 411 and the second copper film 42. Surface roughening can be carried out via chemical treatment with acids, such as diluted sulfuric acid and aqueous sodium hydroxide solution, or via physical treatment with ultraviolet rays and ozone or plasma.

Since each of the first and second copper films 32, 42 is formed via electroplating techniques, the thickness thereof can be controlled to be less than 6 microns.

By using the method of this invention to form the ultra-thin copper films on a substrate for the production of printed circuit boards, the drawbacks as encountered in the prior art can be eliminated.

With the invention thus explained, it is apparent that various modifications and variations can be made without departing from the spirit of the present invention. It is therefore intended that the invention be limited only as recited in the appended claims.

I claim:

1. A method for manufacturing a copper-clad laminate, comprising the steps of:
preparing rigid plate-shaped first and second carriers having first and second flat surfaces, respectively;
forming ultra-thin first and second copper films on said first and second flat surfaces of said first and second carriers, respectively, via electroplating techniques;
sandwiching a prepreg, which is in the form of a glass-fiber reinforced resin sheet containing a curable resin body, between a first assembly of said first carrier and said first copper film, and a second assembly of said second carrier and said second copper film in a manner that said first and second copper films are brought into contact with two opposite sides of said prepreg;
hot pressing said first and second assemblies and said prepreg so as to completely cure said curable resin body of said prepreg to form a cured resin body that is bonded to and that cooperates with said first and second copper films of said first and second assemblies to form a laminated body; and
removing said first and second carriers from said laminated body.

2. The method of claim 1, wherein each of said first and second copper films has a thickness less than 6 microns.

3. The method of claim 1, wherein said curable resin body is made of epoxy resin.

4. The method of claim 1, wherein each of said first and second carriers is made from a polished steel plate.

5. The method of claim 4, further comprising the step of roughening said first and second flat surfaces of said first and second carriers by acid washing before the formation of said first and second copper films thereon.

6. The method of claim 5, further comprising the step of roughening said first and second copper films by etching techniques before the sandwiching of said prepreg between said first and second assemblies.

7. The method of claim 6, further comprising the step of sandwiching the assembly of said prepreg and said first and second assemblies between two opposing kraft paper sheets before the hot pressing step.
